(19) United States
(12) Patent Application Publication
(10) Pub. No.: US 2010/0124511 A1
(43) Pub. Date: May 20, 2010

(54) Wear-resistant plunger rod

(75) Inventor: Xiao-Peng Li, Taizhou (CN)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(73) Assignee: ZHEJIANG RONGPENG AIR TOOLS CO., LTD.

(21) Appl. No.: 12/458,656

(22) Filed: Jul. 20, 2009

(30) Foreign Application Priority Data
Nov. 20, 2008 (CN) 200820138775.5

(51) Int. Cl. F16J 1/00

(52) U.S. Cl. 417/437; 92/172

(57) ABSTRACT

A wear-resistant plunger rod incorporated in a pump of a paint spraying units comprises: a rod (1) and a connecting unit (2) integrally formed. Said connecting unit (2) is disposed on another end of the rod (1) and connected to a transmission device of a pump of a liquid dispersing means. Said wear-resistant plunger rod is characterized in that: a wear-resistant material (3) is applied on the surface of said plunger rod (1). By applying the material (3) on the surface, the plunger rod (1) is given property of wear resistant which increases the liability and safety and prolongs the operational life of the unit.

### FIELD OF THE INVENTION

The present invention relates to a wear-resistant plunger rod incorporated in a pump of a paint spraying unit.

### BACKGROUND OF THE INVENTION

A plunger rod is an essential element of a pump which incorporated in a paint dispersing unit, its reciprocal movements pumps the air out to mix the paint, forming pluralities of tiny paint drops, thus, user can spray it evenly on a surface of an object. A plunger rod of a conventional air spray unit usually contacts with air only. However, in an electric or airless paint spraying units a plunger rod may contacts with the paint directly. Comparison with the rod which only pumps air, the working condition for said plunger rod is relatively poor. Since variable types of paint contain solvents that may corrode the surface of the rod which has no wear-resistant treatment being processed, the abrasion of the rod occurs eventually and causes the malfunction of the unit.

### SUMMARY OF THE INVENTION

To solve aforementioned defect, the present invention relates to a wear-resistant plunger rod by applying a wear-resistant treatment on the surface thereof.

A wear-resistant plunger rod incorporated in a pump of a paint spraying units comprises: a rod (1) whose a end consists of a connecting hole (5) and a transverse passage (6), and a connecting unit (2); said connecting unit (2) is disposed on another end of the rod (1) and is a projecting block with a hole for connecting to a transmission device of a pump of a liquid dispersing means; said rod (1) and connecting unit (2) are integrally formed.

Said wear-resistant plunger rod is characterized in that: a wear-resistant material (3) whose thickness is in a range of 0.05 to 1.0 mm, is applied on a concavity (4) having same depth and is disposed on a cylindrical surface of said plunger rod (1). Said wear-resistant material (3) can be aluminum oxide ceramic, zirconium oxide ceramic, silicon nitride ceramic or mixture of three. An ultrafine compound powder ceramic can also be added in said wear-resistant material (3) to improve the hardness.

By applying the material (3) on the surface, the plunger rod (1) is processed through a wear-resistant treatment which can reduce the corrosive of the rod and prolong the operational life of the unit.

### BRIEF DESCRIPTION OF THE DRAWING

FIG. 1 is a cross-sectional view of the first embodiment.

FIG. 2 is a cross-sectional view of the second embodiment.

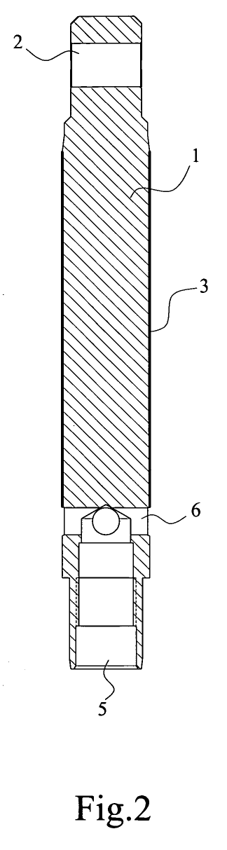

FIG. 3 is a cut away view of the first embodiment, demonstrating the concavity of the surface.

FIG. 4 is a cut away view of the second embodiment, demonstrating the concavity of the surface.

### DETAIL DESCRIPTION OF PREFERRED EMBODIMENT

Description of embodiments of the present invention are described in detail according to the appended drawings hereinafter.

### First Embodiment

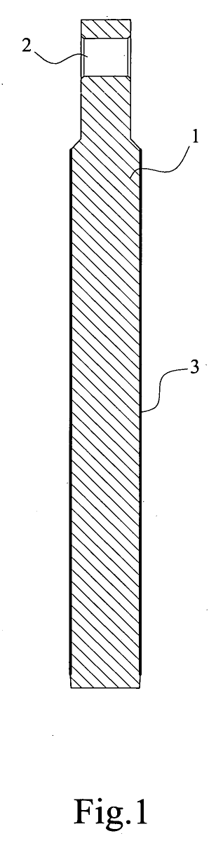

As shown in. FIG. 1, a wear-resistant plunger rod incorporated in a pump (not shown) of a liquid dispersing means comprises: a rod (1) and a connecting unit (2); said connecting unit (2) is on an end of the rod (1) and is connected to a transmission device (not shown) of a pump of a liquid dispersing means; said rod (1) and connecting unit (2) are integrally formed. Said wear-resistant plunger rod is characterized in that: a wear-resistant material (3) is coating on a surface of said rod (1).

Applying a coating of wear-resistant material (3) onto the surface of the rod (1) by spraying, the surface is hardened against corrosion and other kinds of wear. Such method is time-saving, cost effective and the thickness of the coating is adjustable.

Said wear-resistant surface will be processed through a rough finishing and grounded finishing treatment afterward to increase the precision and decrease the unevenness thereof. The hardness and wear resistance is also improving by said processes.

As mentioned above, said plunger rod (1) is incorporated into a pump (not shown) of a liquid dispersing means, more specifically, a paint sprayer; said plunger rod (1) with wear resistant treatment, can improve the tightness between the body and wall of the pump and reduce the wear significantly when moving reciprocally driven by a power unit, and lowering the noise and prolonging the operational life of the means.

### Second Embodiment

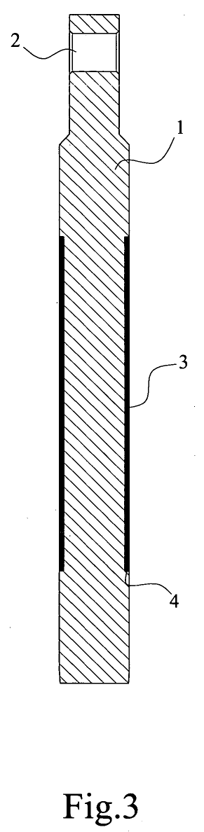

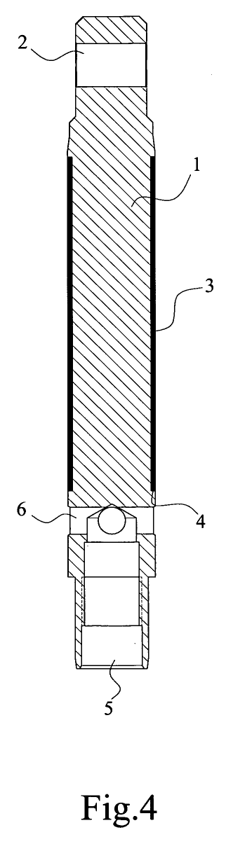

As illustrated in FIGS. 3 and 4, a second embodiment of the present invention is revealed, a wear-resistant plunger rod as disclosed in second embodiment, incorporated in a pump (not shown) of a liquid dispersing means comprises: a rod (1), a connecting unit (2) and a coating made of wear-resistant material (3). Said rod (1) and connecting unit (2) are integrally formed, which means both rod (1) and connecting unit (2) are manufacture from a rod-like material and processed by machine. Said connecting unit (2) is on an end of the rod (1) and is connected to a transmission device (not shown) of a pump of a liquid dispersing means; Said coating of wear-resistant material (3) is applied on a concavity (4), disposed on a cylindrical surface of said rod (1), whose depth corresponds the required thickness of said wear-resistant material (3).

The plunger rod of the second embodiment has the same main structure as disclosed in the first embodiment, with difference by having a connecting hole (5) and a transverse passage (6) set on a side of the rod (1). Thus, the rod (1) is allowed to have variants in accordance with different requirements under condition that they won't affect the layer of wear-resistant material (3), e.g. having a hollow plunger rod (not shown) for reducing cost and weight.

A rough finishing and grounded finishing treatment are also performed over the wear-resistant surface as first embodiment for increasing the precision and decreasing the unevenness thereof.

Aluminum oxide ceramic, zirconium oxide ceramic, silicon nitride ceramic can be applied on the surface as the wear-resistant material (3). Aluminum oxide is well known for its properties of hardness, thermal and corrosion resistant while Zirconium dioxide offering chemical and corrosion inertness, high density, fracture toughness and hardness; and Silicon nitride is a ceramic with good thermal shock and chemical resistance and is able to withstand high structure load to high temperature and superior wear resistance. The selection is made depending on the cost and working environment of the rod (1). An ultrafine compound powder ceramic can also be added in said wear-resistant material (3) to improve the hardness.

The thickness of the material (3) applied on the surface of the plunger rod (1) is set with a range between 0.05 to 1.0 mm. It is believe that said thickness can obtain maximum benefit with minimum cost.

Accordingly, said connecting unit (2) is a projecting block, having a hole and can be pivot jointed with a transmission device (not shown) of a pump of a liquid dispersing means.

By applying the wear-resistant material (3) on the surface, the plunger rod incorporated in a pumping device of paint dispersing means where no lubricant can't be applied thereon is given property against the constant wear and corrosion. With a minimum increase in manufacture cost, the operational life and liability of the device has been prolonged.

While the invention has been illustrated and described, it is not intended to be limited to the detail shown, since various modifications and structural changes may be made without departing in any way from the spirit of the present invention.

What is claimed is:

1. A wear-resistant plunger rod incorporated in a pump of a liquid dispersing means comprises: a rod (1) and a connecting unit (2); said connecting unit (2) is on an end of the rod (1) and is connected to a transmission device of a pump of a liquid dispersing means; said rod (1) and connecting unit (2) are manufactured as a wholeness;
Said wear-resistant plunger rod is characterized in that: a wear-resistant material (3) is applied on a surface of said rod (1).

2. A wear-resistant plunger rod of claim 1, wherein said wear-resistant material (3) is aluminum oxide ceramic, zirconium oxide ceramic, silicon nitride ceramic or mixture thereof.

3. A wear-resistant plunger rod of claim 1, wherein an ultrafine compound powder ceramic is added in said wear-resistant material (3).

4. A wear-resistant plunger rod of claim 1, wherein the thickness of said wear-resistant material (3) is in a range of 0.05 to 1.0 mm.

5. A wear-resistant plunger rod of claim 1, wherein said wear-resistant material (3) is sprayed on the surface of said plunger rod (1).

6. A wear-resistant plunger rod of claim 1, wherein said wear-resistant material (3) is applied on a concavity (4), disposed on a cylindrical surface of said plunger rod (1), whose depth corresponds the required thickness of said wear-resistant material (3).

7. A wear-resistant plunger rod of claim 1, wherein on another end of said rod (1) further includes a connecting hole (5) and a transverse passage (6).

8. A wear-resistant plunger rod of claim 1, wherein said connecting unit (2) is a projecting block, having a hole and can be pivot jointed with a transmission device of a pump of a liquid dispersing means.
